(19) United States
(12) Patent Application Publication
(10) Pub. No.: US 2024/0042950 A1
(43) Pub. Date: Feb. 8, 2024

(54) HIGH-PERFORMANCE VEHICLE-ARCHITECTURE-AGNOSTIC GATEWAY

(71) Applicant: ElectroKnox Corporation, Mountain View, CA (US)

(72) Inventors: Ziyang (Brian) XIONG, San Jose, CA (US); Francis PANG, Mountain View, CA (US); Xinlei QIU, Palo Alto, CA (US)

(73) Assignee: ElectroKnox Corporation, Mountain View, CA (US)

(21) Appl. No.: 18/256,960

(22) PCT Filed: Dec. 20, 2021
(86) PCT No.: PCT/US2021/073034

§ 371 Date: Jun. 12, 2023

Related U.S. Application Data
(60) Provisional application No. 63/127,305, filed on Dec. 18, 2020.

(51) Int. Cl. B60R 16/023; B60R 1/20; B60W 10/18; G10L 15/22; G06F 3/01; H04W 4/40

(52) U.S. Cl. CPC B60R 16/023; B60R 1/20; B60W 10/18; G10L 15/22; G06F 3/017; H04W 4/40

(57) ABSTRACT

A high-performance vehicle network architecture agnostic gateway is disclosed herein. The high-performance gateway includes an application unit, a real-time processing unit, and an image processing unit. The application unit is configured to optimize vehicle operation and maintenance as well as passenger safety and comfort using artificial intelligence and/or machine learning. The real-time processing unit is configured to perform time-sensitive electronic control unit (ECU) sequencing and scheduling based on information received from ECUs across the vehicle network architecture. The image processing unit is configured to detect a speed limit, manage vehicle night vision, inform a lane departure, and identify driver fatigue based on image data received from the ECUs.

### CROSS-REFERENCE

This application claims the benefit under 35 U.S.C. § 119(e) of U.S. Provisional Application Ser. No. 63/127,305 filed Dec. 18, 2020, entitled “HIGH-PERFORMANCE VEHICLE-ARCHITECTURE-AGNOSTIC GATEWAY,” the contents of which is hereby incorporated by reference in its entirety herein.

### BACKGROUND

The “internet of things” has reinvented the way we interact with ordinary appliances. It has enabled consumers to establish and manage a personal network of interrelated appliances, each of which is equipped with a combination of controllers, transceivers, and/or sensors. Accordingly, the “internet of things” has provided consumers with enhanced insight into otherwise routine tasks and has promoted efficiency, autonomy, and control. In the “internet of things”, gateways are commonly used to connect appliances to a cloud network, which enables the consumer to securely and remotely control the controllers, sensors, and/or other appliance components. For example, gateways can be layered—in terms of hardware and/or software—to provide application specific connectivity to connected devices.

Some of the aforementioned appliances include “smart” locks, speakers, refrigerators, washers, dryers, and other common household appliances. However, the aforementioned benefits can also improve the way in which we interact with vehicles (e.g. automobiles, motorcycles, boats, airplanes). For example, the modern automobile is a complex system of computers, sensors, and controls, including electronic control units (ECUs), such as engine control units, configured to optimize or control various systems/components of the vehicle. In fact, modern automobiles can include over one-hundred different ECUs. Although some gateways have been developed for automobile implementation, they are designed for application specific connectivity to connected devices, similar to their household counterparts. As such, conventional gateways are only capable of issuing basic commands and are limited in their ability to relay or route commands between ECUs within an automobile. Furthermore, conventional, microcontroller-based gateways are unable to host virtualized ECUs functionality, which would allow for less hardware and a simplified vehicle architecture.

### SUMMARY

In one general aspect, the present invention is directed to a high-performance vehicle network architecture agnostic gateway. The high-performance gateway includes an application unit, a real-time processing unit, and an image processing unit. The application unit is configured to optimize vehicle operations and maintenance as well as passenger safety and comfort using artificial intelligence and/or machine learning. The real-time processing unit is configured to perform time-sensitive electronic control unit (ECU) sequencing and scheduling based on information received from numerous ECUs across the vehicle network architecture as well as ensuring passenger safety and other time critical vehicle functions. The image processing unit can be configured, for example, to detect a speed limit, manage vehicle night vision, inform a lane departure, and identify driver fatigue to support computational needs for autonomous driving based on image data received from the relevant ECUs.

Accordingly, one benefit of the gateway is that it is architecture agnostic, that is, universally capable of connecting the various sub-systems of an automobile regardless of how the vehicle's controllers, transceivers, and/or sensors are connected to each other, thereby providing the driver and vehicle manufacturer with enhanced insight, autonomy, and control.

These and other benefits that are realized embodiments of the present invention will be apparent from the description that follows.

In one general aspect, a vehicle including a gateway is disclosed. The vehicle can further include a plurality of vehicle subsystems, and a plurality of electronic control unit (“ECUs”), wherein each ECU of the plurality of ECUs is configured to control at least one vehicle subsystem of the plurality of vehicle subsystems. The gateway can be communicably coupled to the plurality of ECUs and can include: an image processing unit configured to: receive image data from an image sensing subsystem of the plurality of vehicle subsystems; and process the image data; an application unit configured to: receive a signal from at least one ECU of the plurality of ECUs; receive the processed image data from the image processing unit; and generate a first instruction and a second instruction based on the processed image data and the received signal; and a real-time response unit configured to: correlate the first instruction to a first consequence and the second instruction to a second consequence; compare the first consequence to the second consequence; and preferentially route the first instruction to a first vehicle subsystem of the plurality of vehicle subsystems prior to routing the second instruction to a second vehicle subsystem of the plurality of vehicle subsystems based on the comparison, wherein receiving the first instruction causes the first subsystem to take a first vehicle action, and wherein receiving the second instruction causes the second subsystem to take a second vehicle action.

### FIGURES

Various embodiments are described herein by way of example in connection with the following figures, wherein:

FIG. 1 depicts a system diagram of a conventional gateway for a vehicle network architecture:

FIG. 2 depicts a system diagram of a high-performance gateway for a vehicle network architecture according to at least one non-limiting aspect of the present disclosure:

FIG. 3 depicts a block diagram of the high-performance gateway of FIG. 2 according to at least one non-limiting aspect of the present disclosure; and

FIG. 4 depicts another block diagram of the high-performance gateway of FIG. 2 according to at least one non-limiting aspect of the present disclosure.

### DESCRIPTION

The present invention is directed, in various embodiments, devices, systems, and methods associated with high-performance gateways that are agnostic of specific vehicle architectures. The present disclosure describes non-limiting aspects wherein the vehicle is an automobile. However, it shall be appreciated that such non-limiting aspects are exclusively presented for illustrative purposes. As such, the term “vehicle” is broadly implemented throughout the present disclosure. A “vehicle” shall be construed to include any number of means of transportation, including bicycles, motorcycles, boats, trains, railcars, and/or airplanes, amongst others.

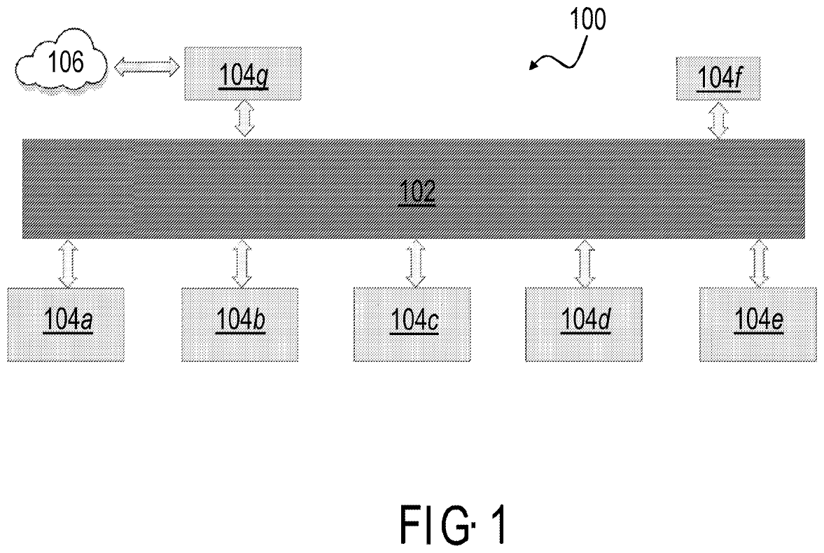

Modern vehicle architectures have evolved away from central configurations towards domain controllers and zonal configurations featuring one or more servers. As previously discussed, conventional vehicle gateways are limited in their functionality and incapable of the enhanced insight, autonomy, and control that modern consumers and manufacturers have come to expect. For example, FIG. 1 depicts a conventional gateway 102 for a specific vehicle architecture 100. As can be seen from FIG. 1, the conventional gateway 102 can be configured to interface with one or more ECUs 104a, 104b, 104c, 104d, 104e, 104f, and 104g. For example, the conventional gateway 102 of FIG. 1 is configured to interface with an advanced driver assistance system (ADAS) 104a, a body and comfort control unit 104h, a powertrain and thermal control unit 104c, a thermal control unit 104d, a user interface control unit 104e, an onboard diagnostics control unit 104f and a communications control unit 104g. The communication control unit 104g can be configured to be communicably coupled to a cloud server 106 via any number of wired or wireless communications, including both long-range and/or short-range networks. For example, the communication control unit 104g can be configured for WiFi®, 4G or 5G cellular. Bluetooth®, and/or nearfield (NFC) communications, amongst others. Similarly, it shall be appreciated that the term “communicably coupled”, as used herein, can refer to any type of wired and/or wireless connection between components, subsystems, and/or servers.

According to FIG. 1, each control unit 104 can be configured to control, connect, and/or communicate with various subsystems and/or components of the vehicle at varying levels of assembly. For example, the ADAS 104a can be communicably connected to a processor configured to at least partially assist the driver in piloting the vehicle. Accordingly, the processor itself can be communicably connected to and configured to control various sensors, a light detection and ranging (LIDAR) system, and/or radars. The body and comfort control unit 104b can be communicably coupled to several other control units, including, but not limited to, the rear body control module (RBCM) and/or the front body control module (FBCM), amongst others. The powertrain and thermal control unit 104c can be communicably coupled to several other control units, including, but not limited to, chassis and/or powertrain controllers, amongst others. The thermal control unit 104d can be communicably coupled to a thermal management controller. The user interface control unit 104e can be communicably coupled to several other control units, including, but not limited to, a user interface, display, and/or video controller, amongst others. The onboard diagnostics control unit 104f can be communicably coupled to several other control units, including, but not limited to, a powertrain control module, a brake control module, a suspension control module, and/or a central timing module, amongst others. As previously discussed, the communication control unit 104g can be communicably coupled to several other control units, including, but not limited to, a WiFi module, a cellular module, an NFC module, and/or a Bluetooth® module, amongst others.

As is depicted in FIG. 1, conventional gateways 102 of FIG. 1 can communicate a limited number of basic commands and/or data between a limited number of ECUs 104a, 104b, 104c, 104d, 104e, 104f, and 104g within an automobile. However, according to a conventional vehicle network architecture, the data generated by the various sensors, actuators, and controllers of the vehicle are processed independently, via a large number of distributed subsystems, after which it is sent to the conventional gateway 102. Although some known platforms involve the processing of data via a centralized cloud computer 106, latency and bandwidth limitations result in an increased lag, leading to unacceptable delays depending on user preference and/or intended application. Since most of the information gathering and processing is done across the various distributed subsystems of a vehicle network architecture, conventional gateways 102 are typically specifically configured to be implemented for either one or a few types of vehicles, reducing the potential for standardization and thus, hindering a manufacturer's ability to implement a single gateway 102 design efficiently.

The aforementioned limitations of conventional gateways 102 become increasingly compounded as modern vehicles continue to evolve into complex computer systems featuring innumerable subsystems, sensors, controllers, and interfaces. Accordingly, there is a need for a new gateway, capable of serving as a customizable backbone for a vehicle network architecture, configured to connect and communicate with the various distributed systems, subsystems, sensors, controllers, and interfaces of modern vehicles. Such a gateway would represent a technological improvement over the conventional gateway 102 of FIG. 1, because it would be capable of not only processing but also synthesizing information generated throughout the vehicle network architecture, thereby providing both drivers and manufacturers alike with a comprehensive snapshot of the vehicle's condition, while simultaneously reducing conventional gateway 102 response time and vehicle architecture 100 complexity. Because such a gateway would be configured to interface with each of a number of distributed systems but could process and synthesize the raw data it received independent of those systems, it would be “agnostic” to any one vehicle network architecture and therefore, more versatile than the conventional gateway 102 of FIG. 1.

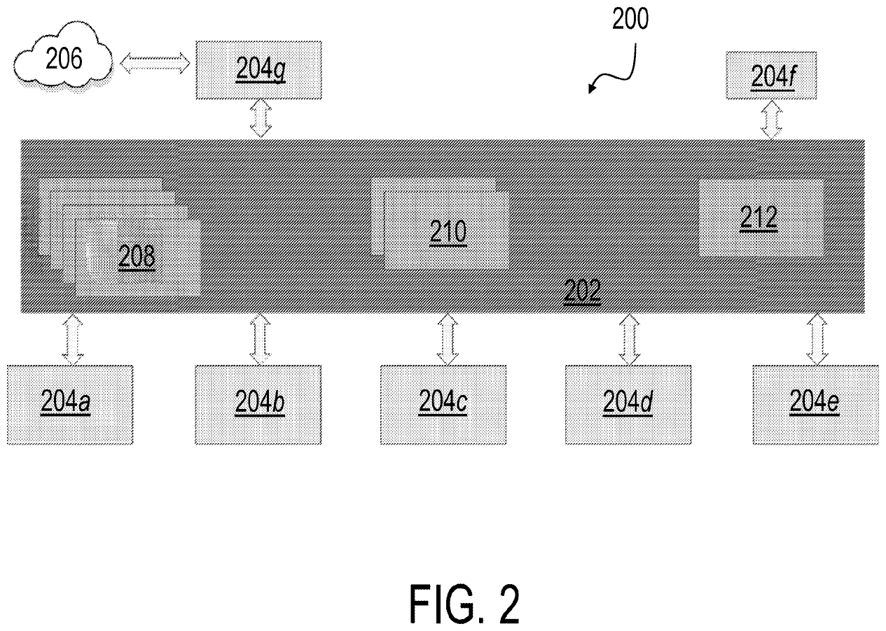

Referring now to FIG. 2, a high-performance gateway 202 for a vehicle network architecture 200 is depicted in accordance with at least one non-limiting aspect of the present disclosure. According to the non-limiting aspect of FIG. 2 the high-performance gateway 202 can be configured to interface with one or more ECUs 204a, 204b, 204c, 204d, 204e, 204f, 204g. Similar to the conventional gateway 102 of FIG. 1, the conventional gateway 202 of FIG. 2 can be configured to interface with an ADAS 204a, a body and comfort control unit 204b, a powertrain and thermal control unit 204c, a thermal control unit 204d, a user interface control unit 204e, an onboard diagnostics control unit 204^{f}, and a communications control unit 204g. Once again, the communication control unit 204g can be configured to be communicably coupled to a cloud server 206 via any number of wired or wireless communications, including the long-range and/or short-range networks previously discussed.

Similar to the network 100 of FIG. 1, the vehicle network architecture 200 of FIG. 2 can include ECUs 204a-g configured to control, connect, and/or communicate with various subsystems and/or components of the vehicle at varying levels of assembly. For example, the ADAS 204a can be communicably connected to a processor configured to at least partially assist the driver in piloting the vehicle. Accordingly, the processor itself can be communicably connected to and configured to control various sensors, a LIDAR system, and/or radars. The body and comfort control unit 204b can be communicably coupled to several other control units, including, but not limited to, the RBCM and/or the FBCM, amongst others. The powertrain and thermal control unit 204c can be communicably coupled to several other control units, including, but not limited to, chassis and/or powertrain controllers, amongst others. The thermal control unit 204d can be communicably coupled to a thermal management controller. The user interface control unit 204e can be communicably coupled to several other control units, including, but not limited to, a user interface, display, and/or video controller, amongst others. The onboard diagnostics control unit 204f can be communicably coupled to several other control units, including, but not limited to, a powertrain control module, a brake control module, a suspension control module, and/or a central timing module, amongst others. As previously discussed, the communication control unit 204g can be communicably coupled to several other control units, including, but not limited to, a WiFi module, a cellular module, an NFC module, and/or a Bluetooth® module, amongst others. Accordingly, the high-performance gateway 202 of FIG. 2 can be configured to communicate with and monitor the performance of any control unit 204 of a vehicle, or in this case, an automobile.

However, unlike the conventional gateway 102 of FIG. 1, the gateway 202 of FIG. 2 can receive, analyze, integrate, and disposition raw information from the ECUs 204 and thus, functionally integrate the components and subsystems of modern vehicles in unprecedented ways. With the addition of multicore processors and programmable logic, the high-performance gateway 202 of FIG. 2 offers additional performance which can include specifically configured control circuits 208, 210, 212 capable of facilitating such integration.

According to the non-limiting aspect of FIG. 2, the high-performance gateway 202 can include an application unit 208, a real-time response unit 210, and an image processing unit 212 configured to work in synergy with the various control units 204 of the vehicle network architecture 200. The application unit 208, the real-time response unit 210, and/or the image processing unit 212, along with other programmable logic blocks, can be components of a field programmable gate array (FPGA) system on chip (SOC). According to some non-limiting aspects, the components can be connected by a grid-like connection which can be configured to connect the logic blocks. For example, the application unit 208, real-time response unit 210, and image processing unit 212 provide the gateway 202 of FIG. 2 with enhanced processing and logic capabilities. This allows the gateway 202 to execute more complex software and thus, control the various ECUs 204, sensors, etc. Conventional microcontroller-based gateways, such as the gateway 102 of FIG. 1, exclude the application unit 208, real-time response unit 210, and image processing unit 212 of FIG. 2 and thus, do not posses the advanced functionality of the gateway 202 of FIG. 2. It shall be further appreciated that each of the application unit 208, real-time response unit 210, and image processing unit 212 can be implemented in the high-performance gateway 202 as specifically configured system-on-a-chips (SOCs). Additionally and/or alternatively, the gateway 202 can utilize any combination of application specific integrated circuits (ASICs), programmable logic devices (PLDs), and/or field programmable gate arrays (FPGAs), amongst others.

The application unit 208 of the high-performance gateway 202 of FIG. 2 can feature one or more advanced reduced-instruction-set computing machines (ARMs) configured to route and/or analyze the information received from the ECUs 204. According to the non-limiting aspect of FIG. 2, the application unit 208 can include a quad-core configuration that constitutes an accelerated processing unit (APU) of the gateway 202. However, the configuration can be modified and/or scaled based on the intended application. In the non-limiting aspect of FIG. 2, the application unit 208 can be configured to analyze and route information received from the ECUs 204 using a variety of artificial intelligence and/or machine learning techniques to optimize vehicle operation and maintenance as well as passenger safety and comfort. For example, according to some non-limiting aspects, the application unit 208 can be configured to analyze and route information received from the ECUs 204 using machine learning classification and regression techniques such as DeepAR forecasting, gradient boosting regression, Gaussian naïve bayes, decision tree in R, and/or random forest, amongst others. According to other non-limiting aspects, the application unit 208 can be configured to analyze and route information received from the ECUs 204 using artificial intelligence techniques such as long short-term memory, recurrent neural network architectures, feedforward neural networks, recursive neural networks, and/or a moving average model, amongst others. Additionally, the application unit 204 can be further configured for “edge computing”, meaning it functions in close proximity to—and oftentimes, in conjunction with—the individual processors and controllers within the ECUs 204. Accordingly, the application unit 208 can be highly integrated with and influential on each of the ECUs 204 dispositioned throughout the vehicle network architecture 200. The integration of ECU-based edge computing combined with artificial intelligence analytical prowess can enable the application unit 208 to improve decision-making, lower response time, and reduce noise. For edge computing can complement cloud computing, to perform more computational tasks and data processing closer to the flow of the source of said data via the use of phones, vehicles, factory robots, smart appliances (e.g., home thermostats, smart locks, lighting hubs, etc.) instead of loading all the data in the cloud prior to processing. In other words, the application unit 208 can be configured for edge computing, meaning it can enable more computational power, artificial intelligence, and/or machine learning, as discussed in further detail below, to enable a vehicle's data to be processed in the vehicle using the gateway 202 of FIG. 2, before vehicle data is uploaded to the cloud. This provides many advantages, including the reduction of data set size, which can enable faster uploads and reduced reliance on a continuous internet connection.

Similar to the application unit 208, the real-time response unit 210 of the high-performance gateway 202 of FIG. 2 can include one or more ARMs configured to process information from the ECUs 204 in real time. According to the non-limiting aspect of FIG. 2, the real-time processing unit 210 can include a dual-core configuration that constitutes a central processing unit of the gateway 202. However, again, the configuration can be modified and/or scaled based on the intended application. In the non-limiting aspect of FIG. 2, the real-time processing unit 210 can be configured to provide security, ensure functional safety, and facilitate the low latency routing of communications between components of the vehicle network architecture 200, including ECUs 204, the application unit 208, and the image processing unit 212. The real-time processing unit 210 can be configured to support real-time processing of information received from the ECUs 204 in conjunction with predetermined time sensitive networking requirements, thereby allowing the gateway 202 to perform time-sensitive ECU control sequencing and scheduling. As such, the real-time processing unit 210 facilitates secure communications at a higher bandwidth with a lower latency across the gateway 202, all of which are required for comprehensive integration of ECUs 204 across the vehicle network architecture 200. For example, according to some non-limiting aspects, the controller area network (“CAN”) latency of the gateway 202 can be improved to approximately 0.9 μs of transmitting latency (“Tₓ”) and approximately 3.9 μs of receiving latency (“Rₓ”). Additionally, the real-time processing unit 210, the application unit 208, and the image processing unit 212, can collectively enable faster processing times. For example, according to some non-limiting aspects, the gateway 202 can offload up to approximately between 70% to 90% of the network traffic from the processors to the programmable logic hardware, leaving nearly all of the processing powers to computations.

According to some non-limiting aspects, the real-time processing unit 210 of the high-performance gateway 202 of FIG. 2 can be further configured to include enhanced prioritization and precision timing protocols to ensure information from the various ECUs is properly managed. For example, the real-time processing unit 210 may preferentially route information from the ADAS ECU 204a above communications from the body and comfort ECU 204b, because they pertain to the safety of the driver above the comfort of the driver.

Accordingly, the gateway 202 can send a control signal for one or more ECU 204 to take a preventive action (e.g. automatically apply the brakes) to avoid a collision before secondary concerns are addressed (e.g. automatically adjust the temperature control in accordance with a predetermined setting). It shall be appreciated that such functionality can enable the gateway 202 to properly synthesize information generated across the vehicle network architecture 200, such that a driver and/or manufacturer can get a comprehensive snapshot of the vehicles condition.

The image processing unit 212 of the high-performance gateway 202 of FIG. 2 can feature one or more graphic processing units (GPUs) configured to process image data received from the ECUs 204. According to the non-limiting aspect of FIG. 2, the graphic processing unit 212 can be configured with computer vision and/or pattern recognition. For example, according to some non-limiting aspects, the graphic processing unit 212 can be configured to utilize computer vision and/or pattern recognition techniques, such as semantic segmentation, object detection algorithms, random cut forrest algorithms, kMeans clustering, isolation forest, and/or one class support vector machines, amongst others. As such, the graphic processing unit 212 can detect the speed limit, manage the vehicle's night vision, inform a lane departure warning system, detect a third party in the vehicle's blind spot, provide parallel parking assistance, recognize features of the driver to identify fatigue, and/or adjust an active cruise control functionality, amongst others. However, the image processing unit 212 can be further configured for non-ADAS vision based functionality, including signal processing for speech and/or gesture command recognition and interpretation, support of the vehicle's infotainment system, and facilitation of various vehicle-to-vehicle communications.

Although the conventional gateway 102 of FIG. 1 may communicate with external SOCs, ASICs, FPGAs, and/or PLDs, the GPU 212 of the high-performance gateway 202 of FIG. 2 streamlines and simplifies the vehicles' overall design. Additionally, the inclusion of a central GPU 212 into the high-performance gateway 202 of FIG. 2 can provide and/or contribute to the enhanced processing capabilities of gateway 202. For example, the GPU 212—either alone, or in conjunction with other components such as an FPGA, multicore processors, etc.—can allow the gateway 202 to receive and process information received from the ECUs 204 relative to other inputs, thereby allowing for more efficient processing, lower latency, and improved prioritization of information generated across the vehicle network architecture 200.

In further reference to FIG. 2, the high-performance gateway 202 of FIG. 2 can be configured to receive, manage, and/or process information it receives from the control units 204, far exceeding the capabilities of the conventional gateway 102 of FIG. 1. In other words, the high-performance gateway 202 of FIG. 2 is configured to serve as a hub capable of integrating information, communication, and action across the vehicle network architecture 200. Whereas the conventional gateway 102 of FIG. 1 was specifically configured for a central implementation, the high-performance gateway 202 of FIG. 2 can be configured as a central gateway and/or a zonal gateway. Unlike the vehicle network architecture 100 of FIG. 1, the vehicle network architecture 200 of FIG. 2 can include physical ECUs, virtual ECUs, and/or combinations thereof. Accordingly, the high-performance gateway 202 of FIG. 2 can be “agnostic” meaning adapted for any vehicle network architecture 200. Even within a particular vehicle network architecture 200, the high-performance gateway 202 of FIG. 2 can be implemented to interface with the various ECUs 204 and cloud server 206 in various ways, providing the user with unprecedented flexibility and adaptability when designing a particular model and/or line of vehicles.

For example, as vehicle network architectures continue to evolve away from a central architecture, such as the vehicle network architecture 100 of FIG. 1, the high-performance gateway 202 of FIG. 2 can support the vehicle network architecture 200 as a domain controller within a specific domain or a zonal gateway. This versatility is due to the gateway 202 being specifically configured to support a number of standard software and hardware interfaces, which allow it to be integrated into any vehicle network architecture, including the vehicle network architectures 100, 200 of FIGS. 1 and 2. The standardized interfaces of gateway 202 can accommodate any ECU 104, 204 and perform a comprehensive assessment of any vehicle network architecture, thereby reducing the need for continuous research and development investment and enabling the standardization of vehicle manufacturing processes.

According to one non-limiting aspect, the high-performance gateway 202 of FIG. 2 can be implemented as a domain controller configured to manage information across multiple domains. This is possible due to the improved power and processing capacity of the underlying microprocessor and FPGA architecture, as previously discussed, which further distinguish it as a technological improvement over the conventional gateway 102 of FIG. 1.

For example, using the aforementioned standardized interfaces and enhanced processing architecture, the gateway 202 of FIG. 2 can be configured to serve as a domain controller for the powertrain domain, body and chassis domain, infotainment domain, and/or telematics domain, amongst others. Accordingly, the high-performance gateway 202 can be configured to manage cross-domain functionality, in a distributed manner. This allows for the simultaneous support, management, and prioritization of critical vehicle features and resources, including safety, cyber security, and/or power management, amongst others.

According to other non-limiting aspects, the vehicle network architecture 200 can be zonally implemented, meaning the high-performance gateway 202 can be configured to support the computing and networking requirements of virtual ECUs 204. This gateway 202 configuration can reduce the number of physical ECUs required by the vehicle. Furthermore, when implemented zonally, the gateway 202 can also be customized to simultaneously run multiple applications and computational processes, traditionally managed by several systems throughout the vehicle network architecture 200. As such, the high-performance gateway 202 can reduce and/or simplify the vehicle network architecture 200, thereby providing efficiency and cost savings for consumers and manufacturers alike.

It shall be appreciated that the aforementioned architecture can be specifically configured to allow the high-performance gateway 202 to be implemented as a backbone of the vehicle network architecture 200. In other words, raw data from the various ECUs can converge in the gateway 202 for processing, analysis, communication, and/or dispositioning, instead of that data being managed independently and in silos, as is common in conventional systems. Accordingly, the high-performance gateway 202 is capable of providing the driver and/or manufacturer with a holistic assessment of the vehicle network architecture 200 beyond the capability of the conventional gateway 102 of FIG. 1. For example, in the event of individual ECU failure and/or communication loss, the high-performance gateway 202 of FIG. 2 can assess other information from across the vehicle network architecture 200 to provide diagnostic alerts and ultimately, support subsequent driver maneuvers and remedial action. Additionally and/or alternatively, the high-performance gateway 202 of FIG. 2 can use artificial intelligence to assist the driver throughout their commute based on information collected from ECUs 204 and the vehicle network architecture 200, as a whole. In this way, other non-limiting aspects include a high-performance gateway 202 configured to assist inexperienced drivers and/or elderly drivers based on experience or capability.

The gateway 202 architecture, as previously discussed, is configured to provide drivers with the aforementioned benefits, because of its unique ability to integrate, process, and disposition information from numerous modules across the vehicle network architecture 200. For example, the aforementioned safety features may harvest and process information from an erratic vehicle behavior detection module, an anomalous driving detection module, a high-risk object detection module, a collision prevention module, a cyber-security module, and/or an attack prevention module. Thus, the gateway 202 can provide unparalleled safety features and redundancy, thereby protecting occupants, pedestrians, and other drivers in early stages. Alternatively and/or additionally, the gateway 202 can gather and process information from diagnostic modules, thereby resulting in preventive maintenance reports, diagnostic information, and/or other customized outputs. As such, mechanics can be provided with a thorough report of the vehicle network architecture 200 and thus, the vehicle's health prior to the driver bringing it into the shop. Additionally and/or alternatively, the gateway 202 can facilitate remote repair of the vehicle, without the vehicle ever having to be brought in to the shop. Such an assessment can be helpful for inspections, maintenance, and/or recalls. In other non-limiting aspects, the driver can be provided with a preventative maintenance plan and/or driving recommendations that are customized for their vehicle. Obviously, these features can reduce the risk of significant and expensive repairs.

Accordingly, it shall be appreciated that the gateway 202 of FIG. 2 represents a technological improvement over the conventional gateway 102 of FIG. 1, which can provide both drivers and/or manufacturers alike with innumerable benefits. The reduced latency and enhanced decision making can reduce the load on other components 204 of the vehicle network architecture 200, and cloud server 206, and can reduce the amount of physical hardware (e.g., ECUs) within the vehicle. As such, the high-performance gateway 202 of FIG. 2 can enhance safety through redundancy, support autonomous driving at advanced levels (e.g., L3 and L4), enhance a driver's experience and insight, and enhance maneuvering capabilities in corner case scenarios, thereby paving the road to building a natural confidence in autonomous driving. The gateway 202 can further improve privacy and security via the detection of cyber-intrusion and/or hacking threats while improving processing speed and efficiency. The gateway 202 represents a technological improvement in computational resources utilized within vehicles such as automobiles and can evaluate raw information across multiple ECUs, simultaneously enhancing capability while reducing bandwidth and latency.

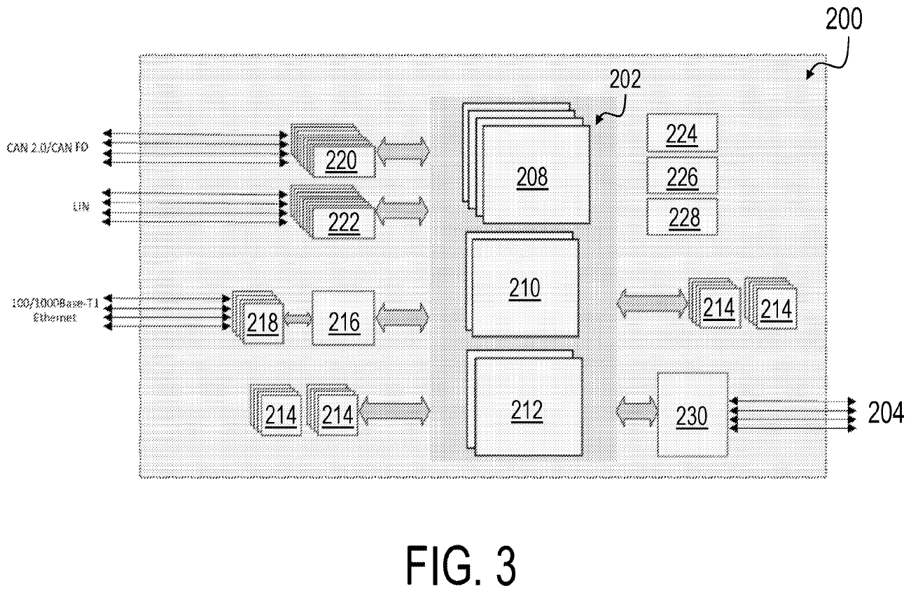

Referring now to FIG. 3, a block diagram of the high-performance gateway 202 of FIG. 2 is depicted in accordance with at least one non-limiting aspect of the present disclosure. According to the non-limiting aspect of FIG. 3, the gateway 202 can be configured to manage information across several memories 214 dispositioned throughout the vehicle network architecture 200. Additionally, the gateway 202 can be communicably coupled to an Ethernet switch 216 and/or physical Ethernet component 218 of an open system interconnection architecture. According to the non-limiting aspect of FIG. 3, the gateway 202 can be wired to the switch 216 and/or physical Ethernet component 218 via a 100 Base-T1, a 1000 Base-T1, or 10G and beyond, that is suitable based on user preference or intended application.

In further reference to FIG. 3, the gateway 202 can be further coupled to various bus interfaces 220, 222. For example, according to the non-limiting aspect of FIG. 3, the gateway 202 can be coupled to a control area network (CAN) interface 220 and/or a local interconnect network (LIN) interface 222. These interfaces 220, 222 can be configured as a transport layer capable of receiving/transmitting data length of varying sizes. For example, the CAN interface 220 can be configured to communicate in accordance with CAN 2.0 and/or CAN FD protocols, amongst others. However, other protocols can be implemented depending on user preference and/or intended application.

Still referring to FIG. 3, the gateway can be further configured to be coupled to various power management integrated circuits 224, 226, 228 of a vehicle. For example, the gateway 202 of FIG. 3 can be coupled to a full power module 224 of the vehicle, a partial power module 226 of the vehicle, and/or a power management module 228 of the vehicle.

Additionally, the gateway 202 of FIG. 3 is depicted as communicable coupled to a raw data sensor interface 230 of the vehicle. Notably, the raw data sensor interface 230 of the vehicle network architecture 200 of FIG. 3 can utilized standard interfaces, as discussed above, to communicate with various ECUs 204 of the vehicle. Accordingly, the gateway 202 is provided with access to data being generated by the various subsystems, including visual and infrared cameras, LIDAR and even radio detection and ranging (RADAR) systems positioned throughout the vehicle network architecture 200. This promotes versatility and enables the gateway 202 to be agnostic, as all the raw data is channeled through the raw data sensor interface 230 and the processing, integrating, and analysis is performed by the gateway 202 itself.

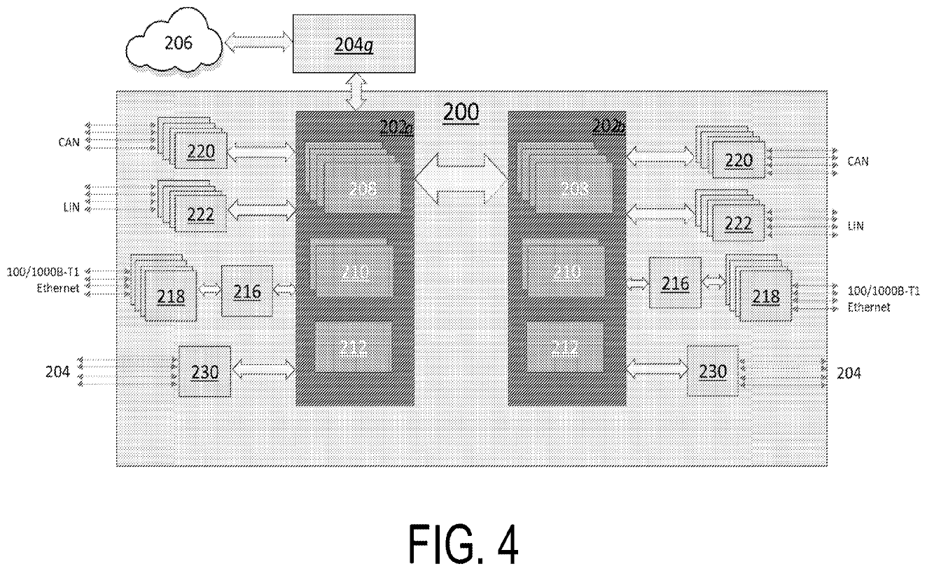

Referring now to FIG. 4, another block diagram of the high-performance gateway 202 of FIG. 2 is depicted according to at least one non-limiting aspect of the present disclosure. According to the non-limiting aspect of FIG. 4, a first gateway 202a can be connected to one or more other high-performance gateways 202b via a high speed, high bandwidth data bus to allow relatively seamless inter-processor communications. According to the non-limiting aspect of FIG. 4, the multi-processor architecture gateway can be applied in vehicles that require: 1) more consolidation of other ECUs features and functionality in the system; 2) additional computational performance while reducing the internal physical space required by multiple gateway units; and/or 3) enhanced functional safety through redundancy where a first gateway 202a connected can function as fail safe for a second gateway 202b and vice versa. With this extended capability, portions of each gateway 202a, 202b can be dedicated to specific computational requirements while overall performance can be maintained or even improved. For example, processors can be dedicated for edge computing/AI computations gathering data from ADAS components, monitoring vehicle functions, and supporting telematics and infotainment videos and displays.

In further reference to FIG. 4, the two high-performance gateways 202a, 202b are depicted as coupled to provide the enhanced functionality discussed above. However, the present disclosure contemplates other non-limiting aspects wherein the high-performance gateway 202a is coupled to any number of conventional gateways 101 (FIG. 1) externally. According to such aspects, the conventional gateway 102 (FIG. 1) can be coupled with the high-performance gateway 202 as if the conventional gateway 102 (FIG. 1) were another ECU 204. As such, the conventional gateway 102 (FIG. 1) could be implemented as a domain controller or a zonal gateway. Nonetheless, it shall be appreciated that the high-performance gateway 202 can also be configured to fulfill those functions, depending on user preference and/or intended application.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

Various aspects of the subject matter described herein are set out in the following numbered clauses:

Clause 1: A vehicle including a gateway, a plurality of vehicle subsystems, and a plurality of electronic control unit (“ECUs”), wherein each ECU of the plurality of ECUs is configured to control at least one vehicle subsystem of the plurality of vehicle subsystems, and wherein the gateway is communicably coupled to the plurality of ECUs and includes: an image processing unit configured to: receive image data from an image sensing subsystem of the plurality of vehicle subsystems, and process the image data; an application unit configured to: receive a signal from at least one ECU of the plurality of ECUs; receive the processed image data from the image processing unit; and generate a first instruction and a second instruction based on the processed image data and the received signal; and a real-time response unit configured to: correlate the first instruction to a first consequence and the second instruction to a second consequence; compare the first consequence to the second consequence; and preferentially route the first instruction to a first vehicle subsystem of the plurality of vehicle subsystems prior to routing the second instruction to a second vehicle subsystem of the plurality of vehicle subsystems based on the comparison, wherein receiving the first instruction causes the first subsystem to take a first vehicle action, and wherein receiving the second instruction causes the second subsystem to take a second vehicle action.

Clause 2: The vehicle according to clause 1, wherein the first consequence is associated with passenger safety and the second consequence is associated with passenger comfort.

Clause 3: The vehicle according to either of clauses 1 or 2, wherein the first subsystem is a braking subsystem of the vehicle, wherein the braking subsystem includes brakes configured to slow the vehicle down, and wherein the first vehicle action is applying the brakes.

Clause 4: The vehicle according to any of clauses 1-3, wherein the application unit includes a first advanced reduced-instruction-set computing machine (“ARM”), wherein the real-time response unit includes a second ARM, and wherein the image processing unit includes a graphical processing unit (“GPU”).

Clause 5: The vehicle according to any of clauses 1-4, wherein the first ARM includes a quad-core configuration that constitutes an accelerated processing unit (“APU”) of the gateway and the second ARM includes a dual-core configuration that constitutes a central processing unit of the gateway.

Clause 6: The vehicle according to any of clauses 1-5, further including a memory configured to store a machine learning algorithm that, when executed by the first ARM, causes the application unit to optimize vehicle operation.

Clause 7: The vehicle according to any of clauses 1-6, wherein the machine learning algorithm includes at least one of DeepAR forecasting, gradient boosting regression, Gaussian Naive Bayes, decision tree in R, and random forest techniques, or combinations thereof.

Clause 8: The vehicle according to any of clauses 1-7, further including a memory configured to store a artificial intelligence algorithm that, when executed by the first ARM, causes the application unit to optimize vehicle operation.

Clause 9: The vehicle according to any of clauses 1-8, wherein the artificial intelligence algorithm includes long short-term memory, recurrent neural network architectures, feedforward neural networks, recursive neural networks, and moving average modeling techniques, or combinations thereof.

Clause 10: The vehicle according to any of clauses 1-9, wherein the GPU is configured with computer vision and/or pattern recognition.

Clause 11: The vehicle according to any of clauses 1-10, wherein the plurality of ECUs include a distributed architecture, and wherein the application processor is configured for edge computing such that at least one of the first instruction and the second instruction are generated in conjunction with at least one ECU of the plurality of ECUs.

Clause 12: The vehicle according to any of clauses 1-11, wherein the graphical processing unit is further configured to receive and process signals associated with a speech command and a gesture command.

Clause 13: The vehicle according to any of clauses 1-12, wherein the gateway is a domain controller for vehicle and configured for real-time, intelligent management of a powertrain domain, a chassis domain, an infotainment domain, and a telematics domain of the vehicle, or combinations thereof.

Clause 14: The vehicle according to any of clauses 1-13, wherein the gateway is configured as a zonal gateway.

Clause 15: The vehicle according to any of clauses 1-14, wherein at least a subset of the plurality of ECUs are virtual and the gateway is communicably coupled to the subset of virtual ECUs via a cloud server.

Clause 16: The vehicle according to any of clauses 1-15, wherein the image processing unit, the application unit, and the real-time response unit are collectively configured such that the gateway has 0.9 μs of transmitting latency, and 3.9 μs of receiving latency.

Clause 17: The vehicle according to any of clauses 1-16, wherein the image processing unit, the application unit, and the real-time response unit are collectively configured such that the gateway offloads between 70% to 90% of network traffic across the gateway.

Clause 18: A gateway configured for use in a vehicle including a plurality of vehicle subsystems, and a plurality of electronic control unit (“ECUs”), wherein each ECU of the plurality of ECUs is configured to control at least one vehicle subsystem of the plurality of vehicle subsystems, and wherein the gateway is configured to be communicably coupled to the plurality of ECUs and includes: an image processing unit configured to: receive image data from an image sensing subsystem of the plurality of vehicle subsystems; and process the image data; an application unit configured to: receive a signal from at least one ECU of the plurality of ECUs; receive the processed image data from the image processing unit; and generate a first instruction and a second instruction based on the processed image data and the received signal; and a real-time response unit configured to: correlate the first instruction to a first consequence and the second instruction to a second consequence; compare the first consequence to the second consequence; and preferentially route the first instruction to a first vehicle subsystem of the plurality of vehicle subsystems prior to routing the second instruction to a second vehicle subsystem of the plurality of vehicle subsystems based on the comparison, wherein receiving the first instruction causes the first subsystem to take a first vehicle action, and wherein receiving the second instruction causes the second subsystem to take a second vehicle action.

Clause 19: The gateway according to clause 18, wherein the first consequence is associated with passenger safety and the second consequence is associated with passenger comfort.

Clause 20: The gateway according to either of clauses 18 or 19, wherein the first subsystem is a braking subsystem of the vehicle, wherein the braking subsystem includes brakes configured to slow the vehicle down, and wherein the first vehicle action is applying the brakes.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure, and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure.

Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B. or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B. and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification.”, and the like means that a particular feature, structure, or characteristic described in connection with the aspect is included in at least one aspect. Thus, appearances of the phrases “in one aspect,” “in an aspect,” “in an exemplification.”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein.

Accordingly. Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modern, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations.

Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

What is claimed is:

1. A vehicle comprising a gateway, a plurality of vehicle subsystems, and a plurality of electronic control unit (“ECUs”), wherein each ECU of the plurality of ECUs is configured to control at least one vehicle subsystem of the plurality of vehicle subsystems, and wherein the gateway is communicably coupled to the plurality of ECUs and comprises:
an image processing unit configured to:
receive image data from an image sensing subsystem of the plurality of vehicle subsystems; and
process the image data;
an application unit configured to:
receive a signal from at least one ECU of the plurality of ECUs;
receive the processed image data from the image processing unit; and
generate a first instruction and a second instruction based on the processed image data and the received signal; and
a real-time response unit configured to:
correlate the first instruction to a first consequence and the second instruction to a second consequence;
compare the first consequence to the second consequence; and
preferentially route the first instruction to a first vehicle subsystem of the plurality of vehicle subsystems prior to routing the second instruction to a second vehicle subsystem of the plurality of vehicle subsystems based on the comparison, wherein receiving the first instruction causes the first subsystem to take a first vehicle action, and wherein receiving the second instruction causes the second subsystem to take a second vehicle action.

2. The vehicle of claim 1, wherein the first consequence is associated with passenger safety and the second consequence is associated with passenger comfort.

3. The vehicle of claim 1, wherein the first subsystem is a braking subsystem of the vehicle, wherein the braking subsystem comprises brakes configured to slow the vehicle down, and wherein the first vehicle action is applying the brakes.

4. The vehicle of claim 1, wherein the application unit comprises a first advanced reduced-instruction-set computing machine (“ARM”), wherein the real-time response unit comprises a second ARM, and wherein the image processing unit comprises a graphical processing unit (“GPU”).

5. The vehicle of claim 4, wherein the first ARM comprises a quad-core configuration that constitutes an accelerated processing unit (“APU”) of the gateway and the second ARM comprises a dual-core configuration that constitutes a central processing unit of the gateway.

6. The vehicle of claim 4, further comprising a memory configured to store a machine learning algorithm that, when executed by the first ARM, causes the application unit to optimize vehicle operation.

7. The vehicle of claim 6, wherein the machine learning algorithm comprises at least one of DeepAR forecasting, gradient boosting regression, Gaussian Naive Bayes, decision tree in R, and random forest techniques, or combinations thereof.

8. The vehicle of claim 4, further comprising a memory configured to store a artificial intelligence algorithm that, when executed by the first ARM, causes the application unit to optimize vehicle operation.

9. The vehicle of claim 8, wherein the artificial intelligence algorithm comprises long short-term memory, recurrent neural network architectures, feedforward neural networks, recursive neural networks, and moving average modeling techniques, or combinations thereof.

10. The vehicle of claim 4, wherein the GPU is configured with computer vision and/or pattern recognition.

11. The vehicle of claim 4, wherein the plurality of ECUs comprise a distributed architecture, and wherein the application processor is configured for edge computing such that at least one of the first instruction and the second instruction are generated in conjunction with at least one ECU of the plurality of ECUs.

12. The vehicle of claim 4, wherein the graphical processing unit is further configured to receive and process signals associated with a speech command and a gesture command.

13. The vehicle of claim 1, wherein the gateway is a domain controller for vehicle and configured for real-time, intelligent management of a powertrain domain, a chassis domain, an infotainment domain, and a telematics domain of the vehicle, or combinations thereof.

14. The vehicle of claim 1, wherein the gateway is configured as a zonal gateway.

15. The vehicle of claim 12, wherein at least a subset of the plurality of ECUs are virtual and the gateway is communicably coupled to the subset of virtual ECUs via a cloud server.

16. The vehicle of claim 1, wherein the image processing unit, the application unit, and the real-time response unit are collectively configured such that the gateway has 0.9 s of transmitting latency, and 3.9 μs of receiving latency.

17. The vehicle of claim 1, wherein the image processing unit, the application unit, and the real-time response unit are collectively configured such that the gateway offloads between 70% to 90% of network traffic across the gateway.

18. A gateway configured for use in a vehicle comprising a plurality of vehicle subsystems, and a plurality of electronic control unit (“ECUs”), wherein each ECU of the plurality of ECUs is configured to control at least one vehicle subsystem of the plurality of vehicle subsystems, and wherein the gateway is configured to be communicably coupled to the plurality of ECUs and comprises:
an image processing unit configured to:
receive image data from an image sensing subsystem of the plurality of vehicle subsystems; and
process the image data;
an application unit configured to:
receive a signal from at least one ECU of the plurality of ECUs;
receive the processed image data from the image processing unit; and
generate a first instruction and a second instruction based on the processed image data and the received signal; and
a real-time response unit configured to:
correlate the first instruction to a first consequence and the second instruction to a second consequence;
compare the first consequence to the second consequence; and
preferentially route the first instruction to a first vehicle subsystem of the plurality of vehicle subsystems prior to routing the second instruction to a second vehicle subsystem of the plurality of vehicle subsystems based on the comparison, wherein receiving the first instruction causes the first subsystem to take a first vehicle action, and wherein receiving the second instruction causes the second subsystem to take a second vehicle action.

19. The gateway of claim 18, wherein the first consequence is associated with passenger safety and the second consequence is associated with passenger comfort.

20. The gateway of claim 18, wherein the first subsystem is a braking subsystem of the vehicle, wherein the braking subsystem comprises brakes configured to slow the vehicle down, and wherein the first vehicle action is applying the brakes.
